(19) United States
(12) Patent Application Publication
(10) Pub. No.: US 2012/0206369 A1
(43) Pub. Date: Aug. 16, 2012

(54) CONTROL METHOD FOR GENERATING FLICKERING COLOR-LIGHT ALTERATION OF ILLUMINATED KEYBOARDS

(76) Inventors: Chin-Wen CHOU, New Taipei City (TW); Chin-Hsiu Hwa, New Taipei City (TW)

(21) Appl. No.: 13/028,785

(22) Filed: Feb. 16, 2011

(51) Int. Cl. G06F 3/02

(52) U.S. Cl. 345/170

(57) ABSTRACT

A control method is to generate flickering color-light alteration of an illuminated keyboard which includes a plurality of keys depressed to provide at least one key-in signal, a plurality of backlight units and a control unit. The illuminated keyboard is divided into a plurality of illumination zones according to the backlight units. The control method includes steps of: first, setting multiple different illumination times corresponding to the backlight units through the control unit; next, detecting the key-in signal not being generated over a preset time or detecting the key-in signal matching a working condition to activate the control unit; and sending out a driving signal respectively by the control unit within the illumination time to the corresponding backlight units to generate illumination asynchronously in the illumination zones.

### FIELD OF THE INVENTION

The present invention relates to a control method for generating illumination of illuminated keyboards and particularly to a control method for alternately generating illumination in illumination zones of an illuminated keyboard.

### BACKGROUND OF THE INVENTION

Keyboards have been widely used as computer input devices. In recent years, illuminated keyboards also have been developed, such as U.S. Pat. Nos. 6,284,988, 6,199,996 and 6,554,442. They all have a light-guide plate in a keyboard to transmit and project light outwards to allow users to recognize key locations in a dark or low illumination intensity environment to avoid erroneous keystrokes.

Aside from illumination, illuminated keyboards capable of generating color-light alterations also have been developed, such as R.O.C. patent No. M256532 which discloses a multi-color illuminated keyboard. It includes a plurality of keys and a multi-color cold light board. The multi-color cold light board has a plurality of illumination zones to generate different color lights. Moreover, the illumination zones correspond to different key sets (such as function keys, numeral keys, direction keys and the like) to provide different backlight colors to facilitate user's recognition.

R.O.C. patent No. M256976 also discloses a multi-color illuminated keyboard. It comprises a keyboard, a cold light sheet with illuminated multi-color segments and a circuit element. The keyboard has an upper lid, an elastic trigger layer, a pliable circuit board, a plurality of keys and a baseboard. The keys are positioned at preset locations of the upper lid and formed in light transmission structure. The cold light sheet is located between the elastic trigger layer and circuit board. The circuit board is connected to a power receiving end of the cold light sheet to provide working power required by the cold light sheet. The cold light sheet has multiple segmented color layers to emit different color lights.

All the aforesaid conventional techniques divide the keyboard into multiple zones and provide different color lights for the zones. However, once the illuminated keyboard is activated, all the zones are illuminated at the same time. The illumination thereof is monotonous without alteration. There is still room for improvement.

### SUMMARY OF THE INVENTION

The primary object of the present invention is to solve the problem of monotonous illumination occurred in the conventional illuminated keyboards.

To achieve the foregoing object, the present invention provides a control method for generating flickering color-light alteration of an illuminated keyboard. The illuminated keyboard includes a plurality of keys depressed to provide at least one key-in signal, a plurality of backlight units and a control unit. The illuminated keyboard is divided into a plurality of illumination zones according to the positions of the backlight units. The control method includes the steps of: a setting step for setting a plurality of different illumination times corresponding to the backlight units through the control unit; a detecting step for detecting the key-in signal matching a working condition to activate the control unit; and a driving step for respectively sending out a driving signal by the control unit within the illumination time to the corresponding backlight units to generate illumination asynchronously in the illumination zones.

In another aspect, the invention also provides a control method for generating flickering color-light alteration of an illuminated keyboard which includes a plurality of keys depressed to provide at least one key-in signal, a plurality of backlight units and a control unit. The illuminated keyboard is divided into a plurality of illumination zones according to the positions of the backlight units. The control method includes the steps of: a setting step for setting a plurality of different illumination times corresponding to the backlight units through the control unit; a detecting step for detecting the key-in signal not being generated over a preset time to activate the control unit; and a driving step for respectively sending out a driving signal by the control unit within the illumination time to the corresponding backlight units to generate illumination asynchronously in the illumination zones.

By means of the techniques set forth above, compared with the conventional techniques, the invention provides many advantages, notably:

1. Through the control method of the invention, the illuminated keyboard can generate illumination asynchronously in varying illumination zones of the illuminated keyboard to present flickering effect to make visual sense more appealing.

2. Depending on user's setting, the illumination zones of the illuminated keyboard can be illuminated with different color lights sequentially to provide colorful and versatile illumination effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of one embodiment of the illuminated keyboard according to the control method of the invention.

FIG. 2 is a perspective view of one embodiment of the illuminated keyboard according to the control method of the invention.

FIG. 3 is a circuit block diagram for implementing the invention.

FIG. 4 is another circuit block diagram for implementing the invention.

FIG. 5 is a flow chart of a first embodiment of the invention.

FIG. 6 is a flow chart of a second embodiment of the invention.

### DETAILED DESCRIPTION OF THE PREFERRED EMBODIMENTS

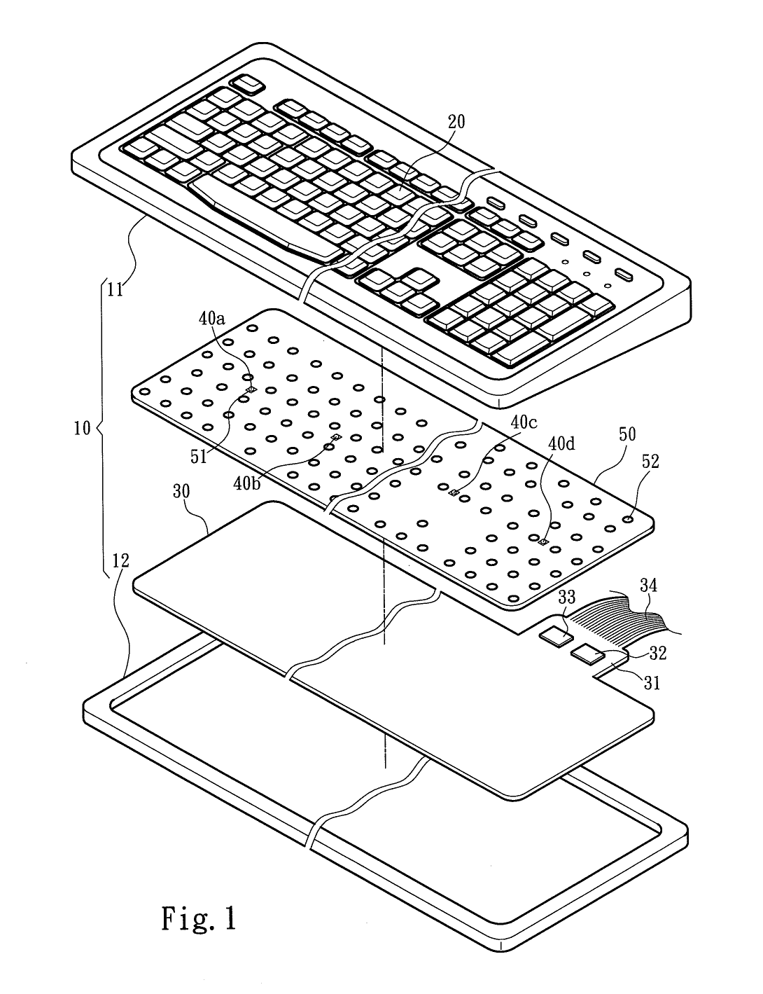

Please refer to FIG. 1 for an embodiment of the invention. The illuminated keyboard used for implementing the control method of the invention includes a housing 10, a plurality of keys 20 depressed by users, a circuit board 30 located in the housing 10, a light-guide plate 50 located between the keys 20 and circuit board 30, and a plurality of backlight units located in the housing 10. The housing 10 includes a top lid 11 and a bottom lid 12. The top lid 11 has openings formed thereon run through by the keys 20. The circuit board 30 is located below the keys 20 and has a plurality of signal contacts corresponding to the keys 20. When being pressed, each key 20 is connected to one signal contact to trigger the signal contact to generate a key-in signal which can be a key code or a character code in a signal array corresponding to the key code. The circuit board 30 is connected to a control unit 32, a signal processing unit 31 and a memory unit 33. Moreover, the light-guide plate 50 also has a plurality of housing troughs 51 to hold the backlight units and a plurality of apertures 52 corresponding to the keys 20.

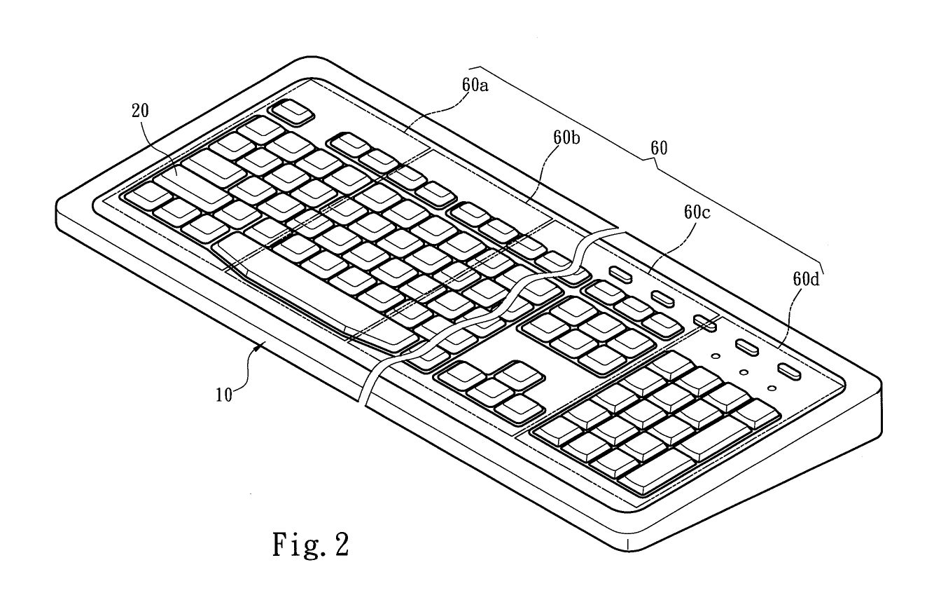

Also referring to FIG. 2, in this embodiment, the backlight units include four sets which are a first backlight unit 40a, a second backlight unit 40b, a third backlight unit 40c and a fourth backlight unit 40d. The illuminated keyboard is divided into a plurality of illumination zones 60 according to the positions of the backlight units including a first illumination zone 60a, a second illumination zone 60b, a third illumination zone 60c and a fourth illumination zone 60d. The first, second, third and fourth illumination zones 60a, 60b, 60c and 60d can include respectively a plurality of different keys 20, or with some of the keys 20 overlapped in the coverage thereof.

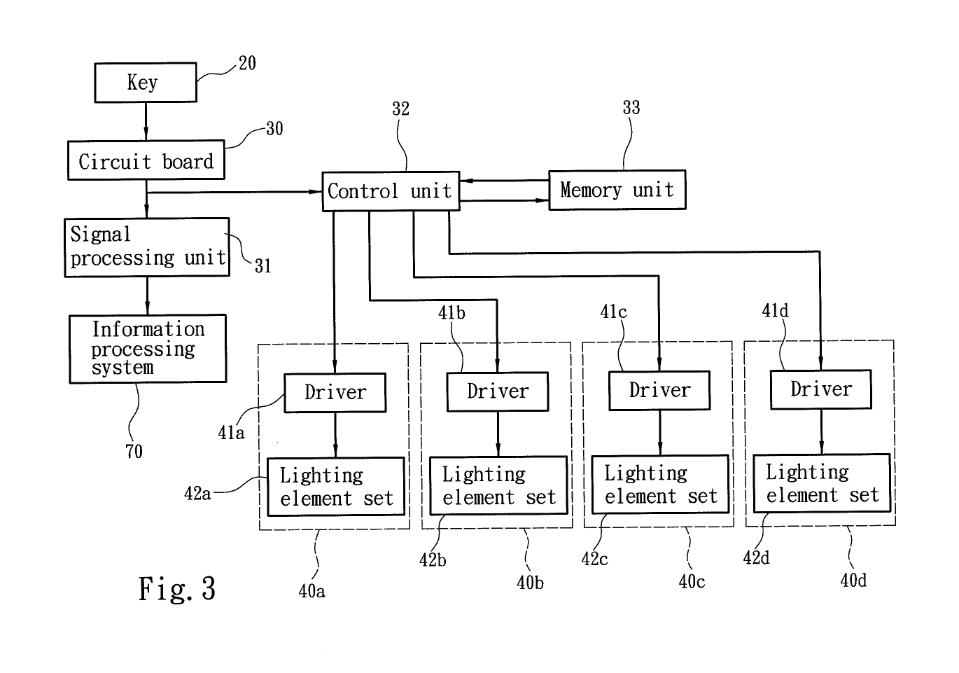

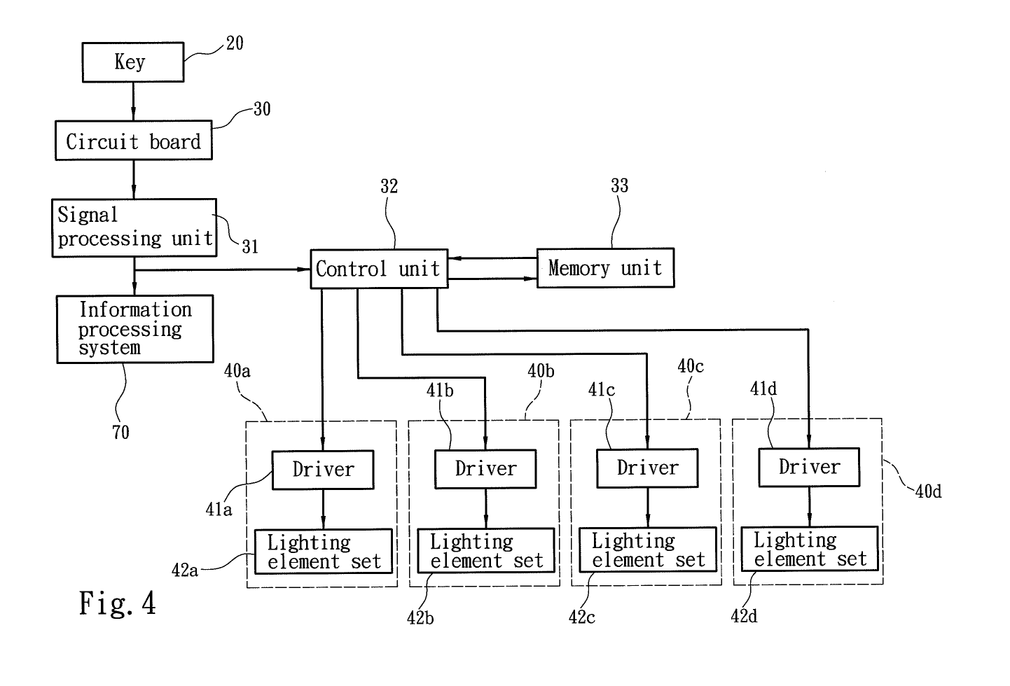

Refer to FIGS. 3 and 4 for two circuit block diagrams of an embodiment of the invention. Each of the first through fourth backlight units 40a, 40b, 40c and 40d includes a lighting element set to provide a mono-color light and a driver to drive the lighting element set, namely the first backlight unit 40a includes a first lighting element set 42a and a first driver 41a, the second backlight unit 40b includes a second lighting element set 42b and a second driver 41b, the third backlight unit 40c includes a third lighting element set 42c and a third driver 41c, and the fourth backlight unit 40d includes a fourth lighting element set 42d and a fourth driver 41d. In other embodiments, each of the first through fourth backlight units 40a, 40b, 40c and 40d can also include a plurality of lighting element sets to provide different color lights and a plurality of drivers to drive each of the lighting element sets. While the embodiment set forth above has four backlight units as an example, it is not the limitation to the invention. More or less than four backlight units also may be used. Based on this, different numbers of the illumination zones 60 are defined on the illuminated keyboard. When one key 20 is pressed by the user, the signal contact is triggered to make the circuit board 30 generate one corresponding key code. The signal processing unit 31 interprets the character code corresponding to the key code, and then the character code is sent out to an information processing system 70 which can be a computer. As shown in FIG. 3, the control unit 32 receives the key code generated by the circuit board 30, or receives the character code generated by the signal processing unit 31 as shown in FIG. 4.

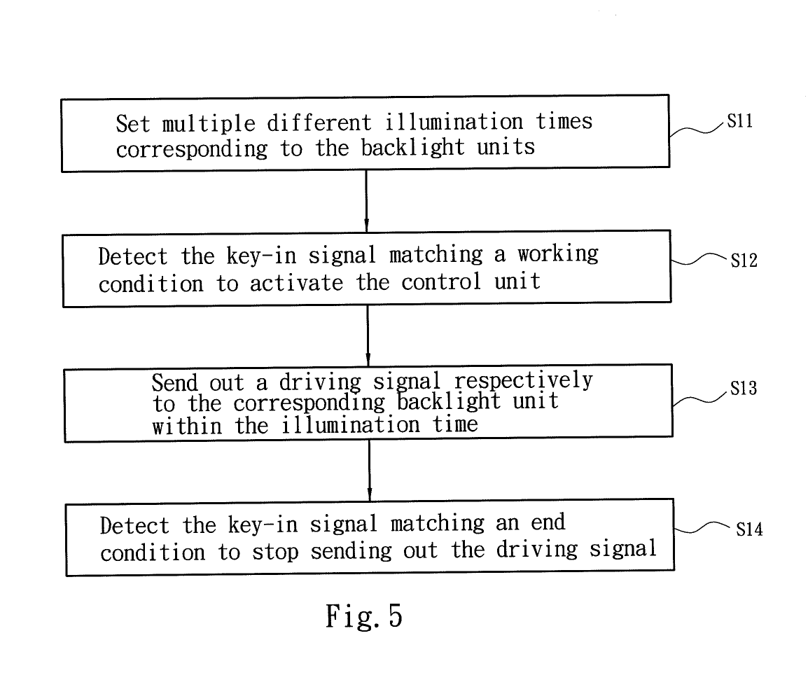

Please refer to FIG. 5 for the flow chart of a first embodiment of the invention. It includes the steps of: a setting step (S11) for setting a plurality of different illumination times corresponding to the first through fourth backlight units 40a, 40b, 40c and 40d through the control unit 32; a detecting step (S12) for detecting the key-in signal matching a working condition to activate the control unit 32; a driving step (S13) for respectively sending out a driving signal by the control unit 32 within the illumination time to the corresponding first through fourth backlight units 40a, 40b, 40c and 40d to allow the first through fourth illumination zones 60a, 60b, 60c and 60d to generate illumination asynchronously; and an end step (S14) to stop sending out the driving signal through the control unit 32 after having detected the key-in signal matching an end condition.

In this embodiment, the illumination times and driving signals corresponding to the first through fourth backlight units 40a, 40b, 40c and 40d respectively have four sets. The illumination times include a first illumination time, a second illumination time, a third illumination time and a fourth illumination time. The driving signals include a first driving signal, a second driving signal, a third driving signal and a fourth driving signal. The illumination times can be sequential (such as the second illumination time follows the first illumination time), or can be intervened by a non-illumination time. The control unit 32 does not send out the driving signal during the non-illumination time. Moreover, the illumination times may also be overlapped partially (namely, the first and second illumination times are partially overlapped). In addition, in this embodiment, the working condition can be preset by pressing “Fn” key and one of “F1” to “F12” keys at the same time to generate the key-in signal. When the control unit 32 detects the key-in signal matching the working condition, the driving signal is sent out.

Furthermore, during execution of the setting step (S11), a plurality of driving modes can be pre-stored in the memory unit 33. The driving modes mating with the key-in signals include at least one execution parameter which can be output voltage value or output sequence of the driving signals, a period value of the illumination times, or the like. The detecting step (S12) and driving step (S13) may also be interposed by a judging step, in which the control unit 32 judges whether the key-in signal matches one of the driving modes, then at the driving step (S13), the control unit 32 draws the driving mode from the memory unit 33 and sends out the driving signal based on the execution parameter of the driving mode. Hence, the control unit 32 can determine the illumination intensity, sequence of generating the illumination, individual illumination time and the like of the first through fourth backlight units 40a, 40b, 40c and 40d based on the execution parameter. In another embodiment, each driving mode can mate with a combination of one key among “F1” to “F12” keys and “Fn” key. For instance, when the “Fn” and “F1” keys are pressed by the user at the same time, the control unit 32 gets one driving mode; when the “Fn” and “F2” keys are pressed by the user at the same time, the control unit 32 gets another driving mode, etc. Each driving mode represents different output voltage value or different output sequence of the driving signals, or a different period value of the illumination times.

For instance, when the illumination times are set at a sequence of the first illumination time, the second illumination time, the third illumination time and the fourth illumination time, the control unit 32 outputs the driving signals sequentially according to the illumination times to the first through fourth backlight units 40a, 40b, 40c and 40d so that the first through fourth illumination zones 60a, 60b, 60c and 60d generate illumination alternately. Namely, within the first illumination time, the control unit 32 merely sends out the first driving signal to the first driver 41a to drive the first lighting element set 42a so that only the first illumination zone 60a in the illumination zone 60 generates illumination. After the first illumination time is elapsed and the second illumination time arrives, the control unit 32 stops sending out the first driving signal to the first driver 41a, and sends out the second driving signal to the second driver 41b to drive the second lighting element set 42b so that only the second illumination zone 60b in the illumination zone 60 generates illumination; meanwhile, the rest of the first, third and fourth illumination zones 60a, 60c and 60d do not generate illumination. Such an approach makes the first through fourth illumination zones 60a, 60b, 60c and 60d generate illumination alternately.

Furthermore, in this embodiment, different driving signals also can provide different illumination intensity for the first through fourth lighting element sets 42a, 42b, 42c and 42d. For instance, the first, second, third and fourth driving signals can be set at increasing or decreasing voltage values to make the first, second, third and fourth illumination zones 60a, 60b, 60c and 60d to generate illumination alternately in an increasing or decreasing illumination manner. In other embodiments, the first through fourth backlight units 40a, 40b, 40c and 40d may include a plurality of lighting element sets to provide different color lights which are determined by the different driving signals. Thus, the first through fourth illumination zones 60a, 60b, 60c and 60d can emit light with varying colors alternately. Finally, during the end step, an end condition similar to the working condition also can be preset by pressing “Fn” and “Esc” keys at the same time to generate the key-in signal. The control unit 32 stops sending out the driving signal after having detected the key-in signal matching the end condition.

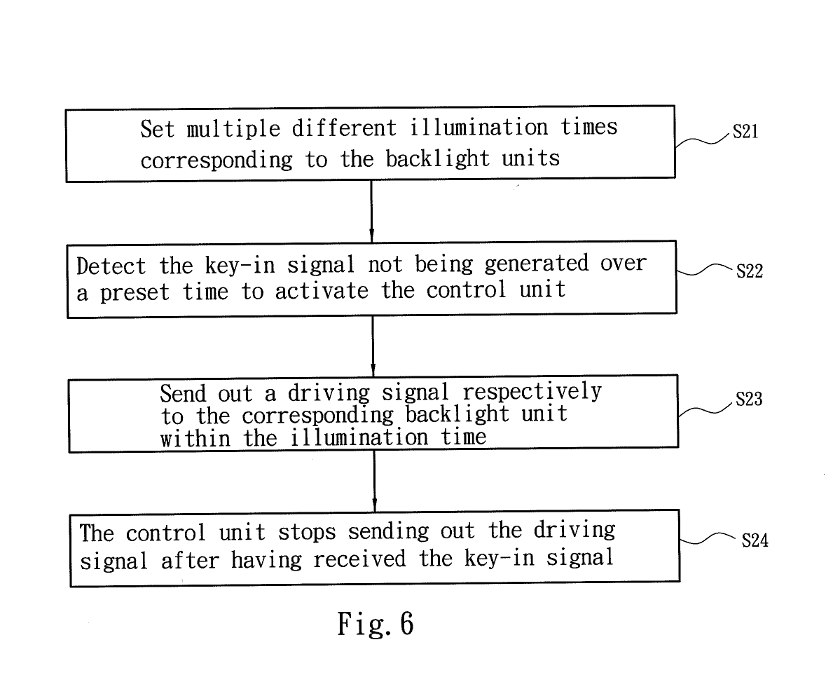

Please refer to FIG. 6 for the flow chart of a second embodiment of the invention. It includes the steps of: a setting step (S21) for setting a plurality of different illumination times corresponding to the illumination zones through the control unit 32; a detecting step (S22) for detecting the key-in signal not being generated over a preset time to activate the control unit 32; a driving step (S23) for respectively sending out a driving signal by the control unit 32 within the illumination time to the corresponding backlight units to generate illumination asynchronously in the illumination zones; and an end step (S24) to stop sending out the driving signal through the control unit 32 after having received the key-in signal.

The procedures of the second embodiment also can be implemented through the illuminated keyboard and circuit architecture depicted in FIGS. 1 through 4. When the keys 20 are idled over a preset time without being pressed, the control unit 32 is activated to respectively send out the driving signal within the illumination time to the corresponding backlight unit. Moreover, a driving mode which includes at least one execution parameter may also be pre-stored in the memory unit 33. The execution parameter can be output voltage value or output sequence of the driving signals, a period value of the illumination times, or the like. During execution of the driving step (S23), the control unit 32 sends out the driving signal according to the execution parameter. In this embodiment, the end step (S24) is to stop sending out the driving signal after the control unit 32 has received the key-in signal when one of the keys 20 is pressed by the user.

As a conclusion, the control method for generating flickering color-light alteration of illuminated keyboards provided by the invention mainly divides the illuminated keyboard into a plurality of illumination zones according to the positions of the backlight units; through the control unit, the driving signal is respectively sent out in different illumination times so that the backlight units generate illumination alternately according to a set sequence, thereby the illuminated keyboard can present flickering illumination. On the other hand, by changing the illumination intensity and color alteration of the backlight units, the illuminated keyboard can emit different color lights asynchronously to provide colorful and versatile illumination effect. It provides a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A control method for generating flickering color-light alteration of an illuminated keyboard which includes a plurality of keys depressed to provide at least one key-in signal, a plurality of backlight units and a control unit, and a plurality of illumination zones defined according to the positions of the backlight units, comprising the steps of:
a setting step, setting a plurality of different illumination times corresponding to the backlight units through the control unit;
a detecting step, detecting the key-in signal matching a working condition to activate the control unit; and
a driving step, respectively sending out a driving signal by the control unit within the illumination time to the corresponding backlight units to generate illumination asynchronously in the illumination zones.

2. The control method of claim 1, wherein the setting step further defines a plurality of driving modes which comprise at least one execution parameter corresponding to the key-in signal through a memory unit.

3. The control method of claim 2 further comprising a judging step interposed between the detecting step and the driving step to judge whether the key-in signal matches the driving modes through the control unit and outputs the driving signal according to the execution parameter in the driving step.

4. The control method of claim 2, wherein the execution parameter is selected from the group consisting of an output voltage value of the driving signal, an output sequence of the driving signal, and a period value of the illumination time.

5. The control method of claim 1 further comprising an end step after the driving step to stop sending out the driving signal through the control unit after having detected the key-in signal matching an end condition.

6. The control method of claim 1, wherein the illumination times are intervened by a non-illumination time without sending out the driving signal.

7. The control method of claim 1, wherein the illumination times are partially overlapped.

8. The control method of claim 1, wherein the backlight unit includes a lighting element set to provide a mono-color light, different driving signals determining different illumination intensity of the lighting element sets.

9. The control method of claim 1, wherein the backlight unit includes a plurality of lighting element sets to provide different color lights, different driving signals determining different light colors of the lighting element sets.

10. The control method of claim 1, wherein the key-in signal is a key code generated by connection of the pressed key and a circuit board.

11. The control method of claim 1, wherein the key-in signal is a character code in a signal array corresponding to a key code generated by connection of the pressed key and a circuit board.

12. The control method of claim 1, wherein each of the illumination zones includes a plurality of different keys.

13. A control method for generating flickering color-light alteration of an illuminated keyboard which includes a plurality of keys depressed to provide at least one key-in signal, a plurality of backlight units and a control unit, and a plurality of illumination zones defined according to the positions of the backlight units, comprising the steps of:
a setting step, setting a plurality of different illumination times corresponding to the backlight units through the control unit;
a detecting step, detecting the key-in signal not being generated over a preset time to activate the control unit; and
a driving step, respectively sending out a driving signal by the control unit within the illumination time to the corresponding backlight units to generate illumination asynchronously in the illumination zones.

14. The control method of claim 13 further comprising an end step after the driving step to stop sending out the driving signal through the control unit after having received the key-in signal.

15. The control method of claim 13, wherein the illumination times are intervened by a non-illumination time without sending out the driving signal.

16. The control method of claim 13, wherein the illumination times are partially overlapped.

17. The control method of claim 13, wherein the backlight unit includes a lighting element set to provide a mono-color light, different driving signals determining different illumination intensity of the lighting element sets.

18. The control method of claim 13, wherein the backlight unit includes a plurality of lighting element sets to provide different color lights, different driving signals determining different light colors of the lighting element sets.

19. The control method of claim 13, wherein the key-in signal is a key code generated by connection of the pressed key and a circuit board.

20. The control method of claim 13, wherein the key-in signal is a character code in a signal array corresponding to a key code generated by connection of the pressed key and a circuit board.

21. The control method of claim 13, wherein each of the illumination zones includes a plurality of different keys.
